(19) United States
(12) Patent Application Publication
(10) Pub. No.: US 2022/0378661 A1
(43) Pub. Date: Dec. 1, 2022

(54) Resizing tray grid system for medication dosage measuring

(71) Applicant: Andrew Albert Downer, Avon, CT (US)

(72) Inventor: Andrew Albert Downer, Avon, CT (US)

(21) Appl. No.: 17/333,511

(22) Filed: May 28, 2021

(51) Int. Cl. A61J 7/04; A61J 7/02; A61J 7/00

(52) U.S. Cl. CPC A61J 7/049; A61J 7/02; A61J 7/0069; A61J 7/0084; A61J 7/0436

(57) ABSTRACT

A system of grids that allows the user to resize the volume of a tray to measure the desired/prescribed dosage of medication. The system enables the user to resize the tray capacity without having to remove and store parts. The flexibility of the pins or sliders allows the user to move the floor and walls of the tray which allows for any volume and shape of resizing (see exhibit 1).

### BACKGROUND

### 1. Field of the Invention

The present invention relates to personalized medication dispensing automation.

### 2. Description of the Related Art

Many medication dispensers currently require the user to manually count their dosages and arrange them in the dispensers so they can be easily consumed at the prescribed/desired time. This technology eliminates the need to do that by allowing the user to set the dosage size once, at the beginning. This approach also prevents the possibility of overdosing, by not making available additional dosages, if the previous dosage was not consumed. Its low cost makes it economical in single prescription usagescenarios and manual or automated devices.

### BRIEF DESCRIPTION OF THE DRAWINGS

The attached drawings show:

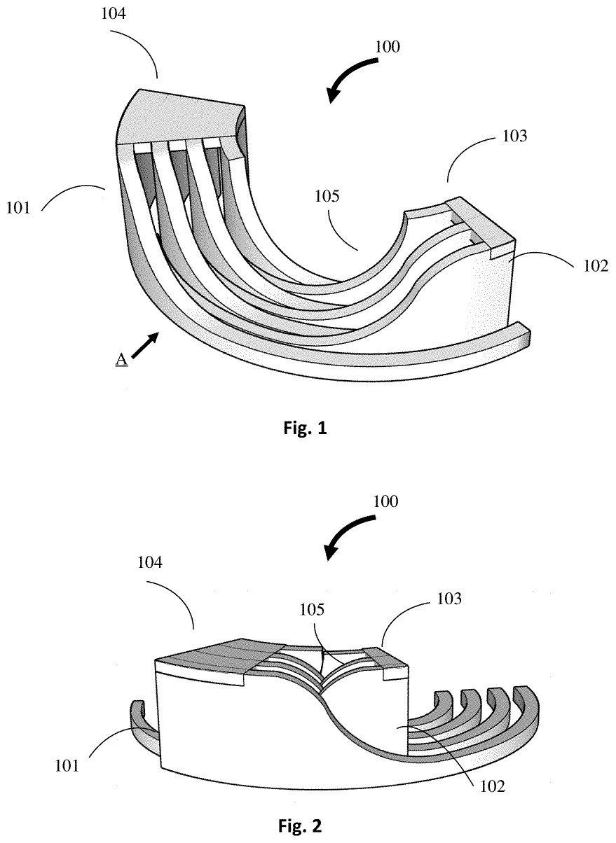

1) FIG. 1: Is a perspective view of curved two piece interlocking tray.

2) FIG. 2: Is a perspective view of tray in FIG. 1 set to measure one Baby Aspirin.

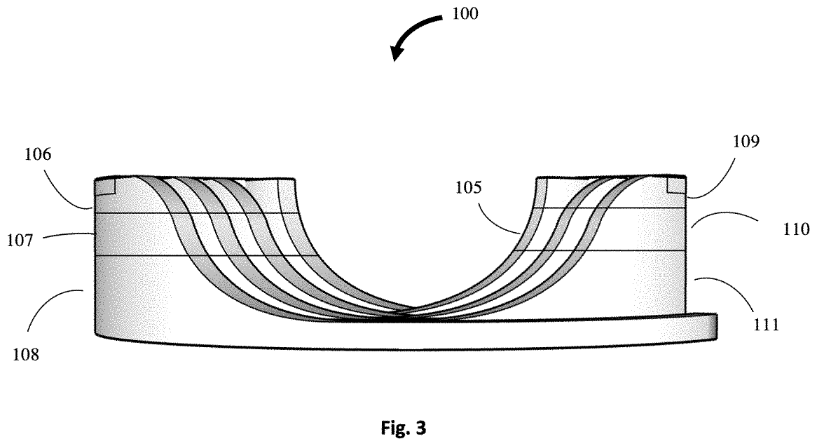

3) FIG. 3: Elevation of tray in FIG. 1 with additional elements stacked vertically.

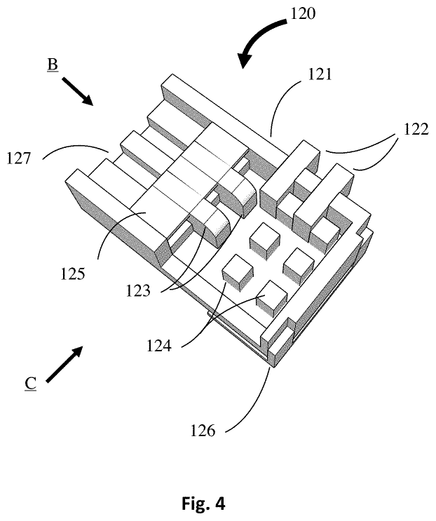

4) FIG. 4: Is a perspective view of a tray with pin and wall elements.

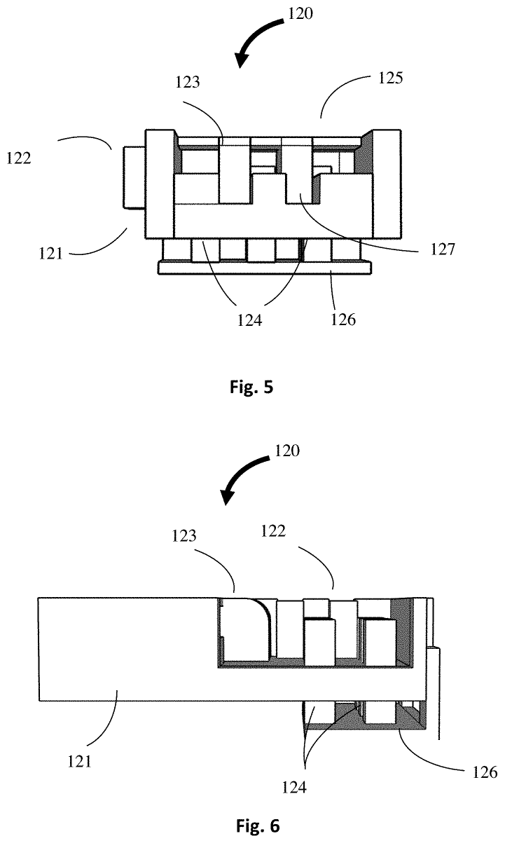

5) FIGS. 5 and 6: Are elevation views of tray in FIG. 4.

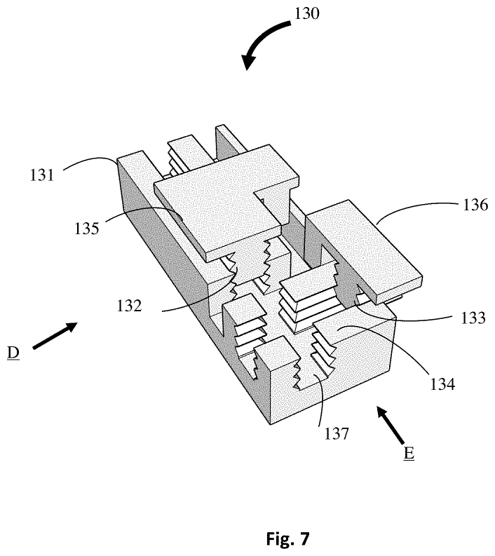

6) FIG. 7: Is a perspective view of a tray with jagged wall depth management.

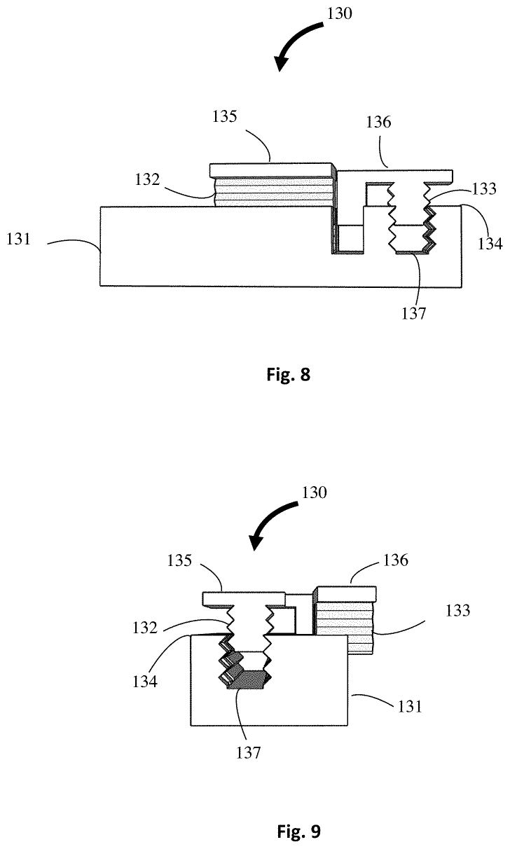

7) FIGS. 8 and 9: Are elevation views of tray in FIG. 7.

### DETAILED DESCRIPTION

The invention provides a low cost mechanical way to measure small dosages of solid form medication. The grid adjusting tray concept allows for universal sizing with no parts requiring removal and storage. It enables the dispensing approach to be overdose proof by preventing multiple dosages from being available at the same time. The present invention is described in enabling detail using the following examples, which describe more than one relevant embodiment falling within the scope of the present invention.

FIG. 1 is a perspective view of a two piece Curved Adjusting Tray 100 according to an embodiment of the present invention. The Curved Adjusting Tray 100 adapted in this example fits the bottle cap application the inventor expects will be the first product to market using the invention. However, the element's 101 and 102 curved nature should not be construed as a critical requirement of the present invention, and thus should not be viewed as a limitation. In one embodiment of the invention, the interlocking elements can be straight, sliding back and forth creating a smooth parabolic cavity 105. In one embodiment, the interlocking elements can have step function tray edges, creating a mirrored staircase tray cavity. In other embodiments, the interlocking elements can have varying edges to create a multitude of tray cavity (wall and bottom) shapes, without departing from the spirit and scope of the present invention.

FIG. 1 is a parabolic shaped tray with an inner surface 105, gapped sufficiently to hold a large pill. The curved wall elements 101 and 102 have bonding elements 104 and 103 preventing the elements from moving relative to their respective grouping. The elements being locked together in groups is not a limitation on the present invention, other embodiments can have each wall element moving independently or as multiple groups on each side, without departing from the spirit and scope of the present invention.

FIG. 2 is a perspective view of Curved Adjusting Tray 100 adjusted to create a small gap 105 small enough to hold only one baby aspirin. The interlocking elements 101 and 102 use the upper convex curves of their edges to create the tray surface 105. The four and three element pairing in 101 and 102 respectively, is not a limitation on the present invention. The inventor also envisions the embodiment of a large number of elements on each side, moving as single elements or multiple groups of elements, enabling the extension of tray capacity and versatility.

FIG. 3 is an elevation view of Curved Adjusting Tray 100 which includes vertical element stacking, element 106, 107, 108, 109, 110 and 111. The inventor wants the reader to have an opportunity to envision the potential variations of tray shape 105 that are possible by changing the shapes or adjustability of the elements. The inventor envisions the ability to change the wall profile 105 by stacking additional elements horizontally and or dividing the elements vertically, without departing from the spirit and scope of the present invention.

FIG. 4 is a perspective view of an Adjusting Tray 120 with straight elements according to an embodiment of the present invention. The body of the unit 121 has square holes at the bottom to accommodate the adjustable floor made up by 6 square pins 124. The pins 124 have a bonding element 126, forcing them to move together. The wall of the unit 121 has tracks 127 to accommodate sliding elements 123, which has a bonding element 125. The second adjusting wall elements 122, slide independent to each other, in slots on the unit body. Elements 122 does not have a bonding element in this embodiment. The bonding elements are not a limitation on the present invention, embodiments with or without any bonding elements or a different number of pins 124 will not be departing for the spirit or scope of the invention. Tray 120 includes grouped elements 123 and 124, and independent elements 122. The independent nature of Elements 122 allows varying movement range for element 123, changing the breath and width of the tray. Movement of Element 124 changes the depth of the tray. The grouping of 124 elements means the depth of the trays will be standard for the entire tray bottom. The ungrouping of the elements in 124, will allow variation in the tray bottom depth.

FIG. 5 is an elevation view of 120, viewed from B.

FIG. 6 is an elevation view of 120, viewed from C. This view shows the side opening where the pills are expected to fall from when tray 120 is embedded in its operating dispenser. The side dispensing in this embodiment is not a limitation, accessing the medication from any other face will not depart from the spirit or scope of the invention.

FIG. 7 is a perspective view 130 of an Adjusting Tray with three straight elements according to an embodiment of the present invention. This walled adjustor version adapted in this example is to demonstrate a ratcheted tray depth locking approach. Elements 132 and 133 creates the adjusting walls of the tray. Their jagged edges interlock with the jagged tracks 137, to maintain the users selected tray depth. The bonding elements 135 and 136 are not limitations to this invention, their absence will not be a departure from this present invention.

FIG. 8 is an elevation view of 130 from position D, the floor of the tray is formed by the surfaces of 134. 137 is the lowest adjustment for walls 132 and 133.

FIG. 9 is an elevation view of 130 from position E.

What is claimed is:

1. A technology that assists in the counting and dispensing of pills. The tray volume size is adjusted by moving and reshaping the sliding elements of the wall[s and floor]. The slides or pins make the volume adjustments adaptable to just about all pills sold.

2. No adjustor parts storage required. No reducing barriers have to be added or removed from the device.

3. A low-cost automation enabling technology for single or multi pill dispensing. The expected cost to manufacture the tray, and the corresponding techniques (gears or clamps) to move and lock the wall elements into position, is less than a dollar. As a result, it is economical for use in a single prescription automated dispenser unlike the current automated counting approaches in the market which rely on sensors and motors to count and sort the pills.

4. (canceled)

5. (canceled)
